(19) United States
(12) Patent Application Publication
(10) Pub. No.: US 2010/0039002 A1
(43) Pub. Date: Feb. 18, 2010

(54) OVERDRIVE GENERATOR

(76) Inventor: Jason E. Allen, Tacoma, WA (US)

Correspondence Address: BLACK LOWE & GRAHAM, PLLC, 701 FIFTH AVENUE, SUITE 4800, SEATTLE, WA, 98104, US

(21) Appl. No.: 12/539,370

(22) Filed: Aug. 11, 2009

Related U.S. Application Data
(60) Provisional application No. 61/188,706, filed on Aug. 11, 2008.

(51) Int. Cl. H02K 1/00; H02K 53/00

(52) U.S. Cl. 310/40 R; 415/916

(57) ABSTRACT

A motor includes a first layer including a first circular conductive winding having a first center portion and mounted to a first plurality of dowel rods connected to the first center portion of the first winding, a second layer including a center-piece element, a spindle, and an outside drive element, the outside drive element including at least one magnet, and a third layer including a second circular conductive winding having a second center portion and mounted to a second plurality of dowel rods connected to the second center portion of the second winding.

### CROSS-REFERENCE To RELATED APPLICATIONS

This application claims priority to U.S. Provisional Appl. No. 61/188,706 filed Aug. 11, 2008, the entirety of which is incorporated by reference as if fully set forth herein.

### BACKGROUND OF THE INVENTION

There are different methods for providing a generator with a crank. For example, most companies may connect the crank of the generator to a two-stroke engine. Another approach uses an electromagnet to drive the crank to turn.

Prior-art devices require gasoline, which is expensive and not always available or is just not cost effective.

The electromagnet version failed for a few reasons, one of which is that the device wastes more power charging the electromagnet than the device produces. Secondly, the polarity that is used to push the crank over is less than the power needed to make a complete rotation, so a full cycle isn't needed.

### BRIEF DESCRIPTION OF THE DRAWINGS

Preferred and alternative embodiments of the present invention are described in detail below with reference to the following drawings.

FIG. 1 illustrates a side exploded view in cross section of a motor according to an embodiment;

FIG. 2 illustrates multiple top views of elements of the motor of FIG. 1 according to alternative embodiments of the invention;

FIG. 3 illustrates top and side views of a spindle according to an embodiment; and

FIG. 4 illustrates a top view of a winding/dowel assembly according to an embodiment.

### DETAILED DESCRIPTION OF THE PREFERRED EMBODIMENT

An embodiment of the invention may be configured to provide power/electricity to communities and electrical devices therein.

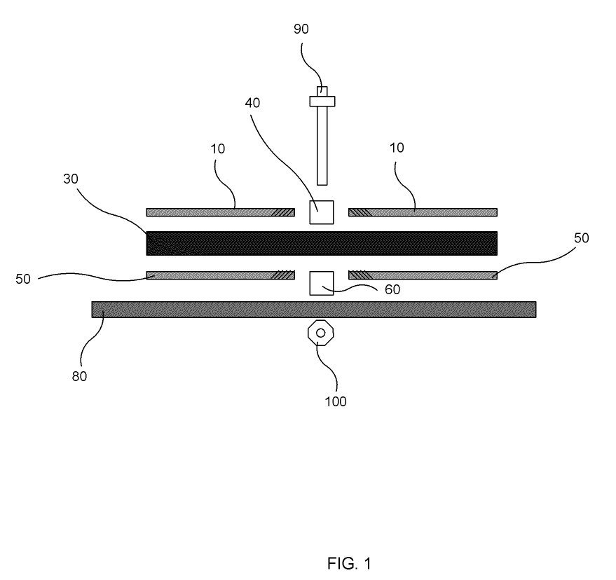

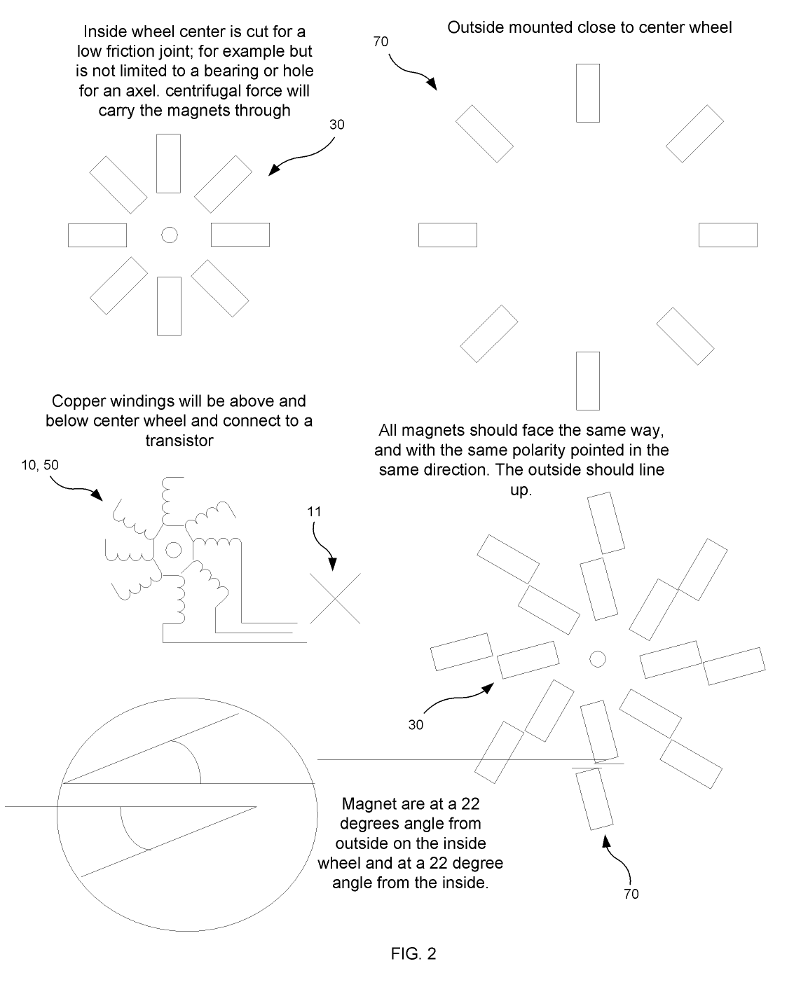

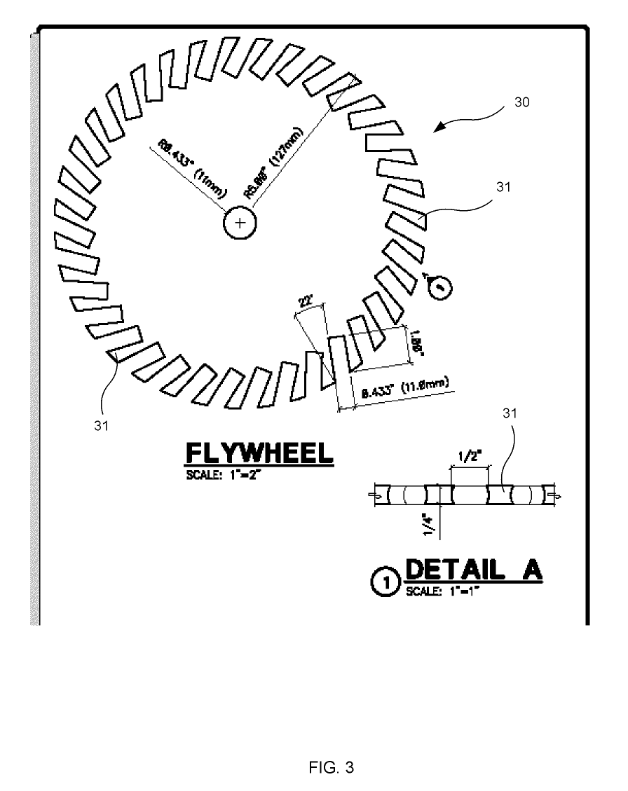

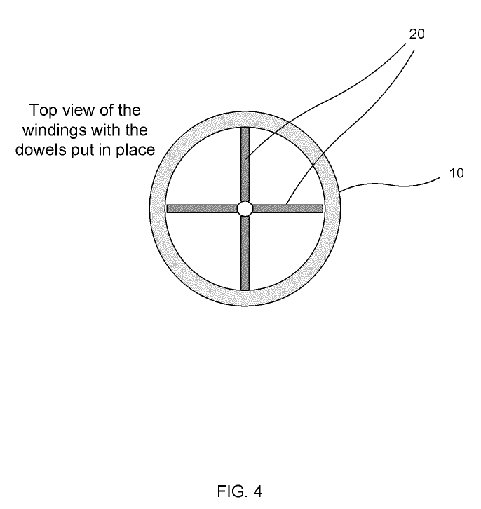

Referring to FIGS. 1 and 4, an embodiment of the invention includes three layers. The first layer includes a first circular winding 10 mounted to four dowel rods 20 that are connected to a dowel rod mount 40 in the center of the winding. The third layer includes a second circular winding 50 similarly mounted to four dowel rods that are connected to a dowel rod mount 60 in the center of the winding. The windings 10, 50 may be connected to a transistor 11 (FIG. 2). Referring to FIGS. 2 and 3, the second layer includes a center mounting piece (not shown), a spindle 30 and an outside drive/casing 70 including one or more magnets. The spindle includes a wheel (flywheel) that may be mounted on the dowel rod mounts 40, 60 into which the windings dowels 20 may be screwed, just an inch higher in an embodiment. The spindle 30, after being securely mounted, has the outside drive 70 dropped over it offset so the drive has an outward spiral configuration and/or effect. The polarities may be the same, so the casing 70 pushes or drives the spindle 30. A base plate 80 may be provided to anchor the above-discussed components using a bolt 90 and nut 100.

Referring to FIG. 3, in an exemplary embodiment, the spindle 30 may be 10 inches in diameter and ¼ inch thick. The spindle 30 may be cut with a drill that is a ½ inch drill bit at a 22-degree angle, although other angles of a different magnitude may be employed. Such a series of cuts around the perimeter of spindle 30 may form a series of magnetized elements 31 around such perimeter. The ½ inch cut may leave ⅛ of the magnets exposed on the top and bottom, but will still be controlled by the spindle 30. The spindle 30 may be mounted to the center piece using bearings, so the spindle can go into a free spin.

The drive/casing 70 may be a large custom-made magnet. In an embodiment, the magnet stands 6 inches tall and is 1½ inches in thickness. The casing 70 can also be composed of one or more magnetized pieces of metal; the measurements may change as one changes things like dimensions and material of which it is composed. The measurements of the gap between the spindle 30 and the casing 70 may change due to changes in magnetic material, such as using magnetized metal or a strong permanent magnet. In an embodiment, there may be a gap from the drive 70 to the spindle 30 about an inch on top, a 2 inch gap on the left side from the spindle to the outside casing, and 3 inch gap on the bottom.

The device, after all constructed and put together, will make the spindle 30 turn and pick up speed until meeting the max RPMs of the bearings.

The magnetic elements 31 may be canted in the spindle 30. The polarity of the magnets 31 can be the same in the spindle 30 as the magnets that are lined up in the drive 70. The magnetic elements 31 may be canted to one side so that the magnetic field will force movement. Having a magnet even with the outside of the spindle 30, as opposed to a cant, can have the same effect (spindle turning) but an embodiment may have the magnets canted. The polarity of the drive 70 can be magnetized long ways. So, if the metal is magnetized, for example, before you bend it to your specifications it would be magnetized short ways not long ways. So, if when you bend it and lay it down so that you're looking at it from the top so it looks like a spiral, the top will be one polarity and the bottom will be the other polarity. So, if there is all positive poles on the outside of the spindle 30, then the side of the casing 70 may be lined up so that the positive is the closest side, otherwise the drive 70 may pull all of the magnets out of the spindle. The magnet for the drive 70 may be about 4 feet long.

An analogy of an embodiment would be a person turning a wheel by pushing the outside rim and instead of using one or two hands, the person uses 10 hands. As the hands go from the twelve o'clock position of the spindle to the 9 o'clock position, there is less force that is used. Basically, the spindle 30 is pushing to go toward a position with less resistance. Once one of the magnets in the spindle 30 gets to the end or is about to move back in to the twelve o'clock position, this is the place of the most resistance. In other words, once the magnet is approaching a full rotation, the force of the other magnets in the spindle push the one magnet at the end of its rotation to continue. The reason that a magnet in the spindle keeps going is the other magnets in the spindle. All of the force from the other magnets adds up to equal more than the resistance from the magnet at the end of the turn.

While a preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A motor, comprising:
a first layer including a first circular conductive winding having a first center portion and mounted to a first plurality of dowel rods connected to the first center portion of the first winding;
a second layer including a center-piece element, a spindle, and an outside drive element, the outside drive element including at least one magnet; and
a third layer including a second circular conductive winding having a second center portion and mounted to a second plurality of dowel rods connected to the second center portion of the second winding.

2. The motor of claim 1, wherein the spindle includes at least one magnetized element.
